(19) United States
(12) Patent Application Publication
(10) Pub. No.: US 2022/0278994 A1
(43) Pub. Date: Sep. 1, 2022

(54) SDN-BASED INTRUSION RESPONSE METHOD FOR IN-VEHICLE NETWORK, AND SYSTEM USING SAME

(71) Applicants: Hyundai Motor Company, Seoul (KR); Kia Corporation, Seoul (KR); Korea University Research and Business Foundation, Seoul (KR)

(72) Inventors: Huy Kang Kim, Seoul (KR); Seong Hoon Jeong, Seoul (KR); Seung Wook Park, Yongin, Gyeonggi-do (KR); Wha Pyeong Lim, Hwaseong, Gyeonggi-do (KR)

(21) Appl. No.: 17/631,836

(22) PCT Filed: Jul. 31, 2020
(86) PCT No.: PCT/KR2020/010141

§ 371 Date: Jan. 31, 2022

(30) Foreign Application Priority Data
Jul. 31, 2019 (KR) 10-2019-0093503
Jul. 30, 2020 (KR) 10-2020-0095518

(51) Int. Cl. H04L 9/40; H04L 47/2441; H04L 45/76

(52) U.S. Cl. CPC H04L 63/1416; H04L 47/2441; H04L 45/76

(57) ABSTRACT

The present disclosure an intrusion prevention (or response) system and method for detecting and preventing a vehicle intrusion by means of an SDN-enabled switch installed in an in-vehicle network (IVN) and an SDN controller communicating with the SDN-enabled switch, the method in which the SDN support switch transmits a packet-in message to the SDN controller, enables an intrusion detection system (IDS) to determine whether a particular packet is an intrusion packet, receives an action according to a result of the determination, and transmits a packet-out message to the SDN-enabled switch so as to control a flow of a particular packet.

### TECHNICAL FIELD

The present disclosure relates to a technology for detecting and blocking an intrusion or attack on an in-vehicle network (IVN).

### BACKGROUND

The contents described in this section merely provide background information for the present embodiment and do not constitute a related art.

Commercial vehicles adopting vehicle-to-everything (V2X) communication and network-based autonomous driving-related technologies have been developed. For example, IEEE 802.11p wireless access in vehicular environment (WAVE), dedicated short-range communication (DSRC), and V2X technologies provide connectivity required in connected and automated vehicles (CAVs).

In order to implement a network-based autonomous driving system using a plurality of sensors and cameras as nodes, it is necessary to develop an in-vehicle communication protocol that may support high bandwidths. The traditional Ethernet-based networks have a problem in that they are not fully compatible with CAVs. Thus, an automotive Ethernet and a “hybrid network”, which may include a controller area network (CAN), traditional Ethernet and automotive Ethernet, have been developed.

Meanwhile, a security threat based on intrusion into a communication network or network is an obstacle to the development of commercial vehicles using V2X communication and those in-vehicle networks. FIG. 1 is a diagram illustrating classification of types of security threats in vehicles. Attacks threatening the security of vehicles include privilege stealing attacks and non-privilege stealing attacks, external attacks based on attack sources, and internal attacks against internal elements vehicles. Internal attacks are usually carried out by attackers by physically accessing a target vehicle to inflict tangible damage, whereas external attacks mainly use sensor-based systems such as short-range RF communications, keyless entry systems, or tire pressure monitoring systems, so a weight thereof is limited. However, as the in-vehicle connectivity in the IVN environment and the inter-vehicle connectivity in the V2X environment increase, an impact of external attacks on vehicles is expected to increase.

Therefore, an intrusion detection methodology in controller area network (CAN) bus-based IVN has been developed. As one of the intrusion detection methodologies, a method of applying machine learning or deep learning algorithms has been introduced, but these algorithms require high computing power to test traffic data and predict or determine whether an attack or intrusion occurs. Accordingly, an external detection architecture has been proposed as an alternative, but the external detection architecture has a problem in compatibility with an in-vehicle environment.

Even when an attack or intrusion is properly detected, how to mitigate the attack or intrusion in response has been a problem. The previously proposed mitigation methods have not been appropriate alternatives to attacks on IVN vehicles.

In other words, there is a lack of development of a technical framework for detecting and appropriately responding to vehicle risks that support V2X and IVN. Currently, an intrusion detection system (IDS) mounted in a vehicle limitedly supports only lightweight algorithms due to a limitation of computing power of a vehicle system. Therefore, it is necessary to devise an intrusion prevention (or response) system for detecting an intrusion and suggesting a response, and to overcome the limitations of such computing power.

### SUMMARY

### Technical Problem

The present disclosure provides a method for detecting and preventing an attack on an Ethernet-based In-vehicle network (IVN) using software-defined networking (SDN) technology, and a system using the same.

### Technical Solution

According to one aspect of the present disclosure, provided is an intrusion prevention system for an in-vehicle network (IVN). The intrusion prevention system comprises a software-defined networking (SDN)-enabled switch installed in the IVN of a vehicle and configured to control a packet flow of an incoming packet by referring to a flow entry, in a flow table, corresponding to the incoming packet, and an SDN controller configured to communicate with the SDN-enabled switch, receive the incoming packet from the SDN-enabled switch, and transmit an action corresponding to the incoming packet to the SDN-enabled switch. The SDN controller is further configured to transmit the incoming packet to an intrusion detection system (IDS) so that the IDS determines whether the incoming packet is an intrusion packet, receive an action based on a determination result from the IDS, and transmit the received action to the SDN-enabled switch, as the action corresponding to the incoming packet.

According to another aspect of the present disclosure, provided is a method for detecting and preventing a vehicle intrusion using a software-defined networking (SDN)-enabled switch installed in an in-vehicle network (IVN) of a vehicle and an SDN controller located remotely from the vehicle. The method comprises: transmitting to the SDN controller, by the SDN-enable switch, a packet-in message which contains an incoming packet flowed from the IVN; receiving, by the SDN controller, the packet-in message and transmitting the received packet-in message to an intrusion detection system (IDS); enabling, by the SDN controller, the IDS to determine whether the incoming packet is an intrusion packet, and receiving, by the SDN controller, an action based on a determination result from the IDS; transmitting, by the SDN controller, a packet-out message including the action based on the determination result to the SDN-enabled switch; and controlling, by the SDN-enabled switch, a packet flow of the incoming packet according to the action based on the determination result.

According to still another aspect of the present disclosure, in the method for detecting and preventing a vehicle intrusion, the transmitting of the packet-in message to the SDN controller is performed when an event occurs that there is no extracted flow entry or that the extracted flow entry has expired, or when a forward-to-controller command is included in an action field of the extracted flow entry.

### Advantageous Effects

An SDN switch of the present disclosure may simultaneously monitor and block traffic flowing into an IVN. That is, the SDN switch may selectively block traffic identified as an attack, while monitoring traffic flowing into a vehicle based on a flow table.

According to the present disclosure, since whether a packet flowing into a vehicle is an intrusion packet and which flow control action to execute are determined remotely, rather than in the IVN, an intrusion packet may be detected based on high-performance detection technology requiring high computing performance, for example, deep learning or artificial intelligence methodology, regardless of an internal environment of the vehicle, and an appropriate response command may be presented according to a detection result. In addition, an intrusion detection system located remotely from the vehicle enables a change or updating of a detection algorithm or model in real time regardless of the vehicle environment.

Furthermore, according to the present disclosure, internal traffic occurring in a plurality of vehicles may be simultaneously and comprehensively monitored in one place. This enables more precise attack detection by gathering vague anomalies that are difficult to detect from a single vehicle and comparing the gathered anomalies with normal traffic of other vehicles.

The technology of the present disclosure may also be applied by adding an SDN device to a common switch provided in an existing Ethernet-based vehicle. Accordingly, the technology of the present disclosure may be applied, while minimizing a change in topology of the Ethernet-based IVN.

### BRIEF DESCRIPTION OF THE DRAWINGS

FIG. 1 is a diagram illustrating classification of types of security threats in vehicles.

FIG. 2 is a conceptual diagram illustrating architecture of a typical Software-Defined Networking (SDN).

FIG. 3 illustrates an SDN controller and an SDN device constituting an SDN system and a configuration field of a flow entry configuring a flow table mounted in the SDN device.

FIG. 4 is a conceptual diagram schematically illustrating a structure of an intrusion prevention system according to an embodiment of the present disclosure.

FIG. 5 is a conceptual diagram schematically illustrating an operation of an intrusion prevention system according to an embodiment of the present disclosure.

FIGS. 6A and 6B are diagrams illustrating an exemplary topology of an in-vehicle network (IVN) according to an embodiment of the present disclosure.

FIGS. 7A and 7B are diagrams illustrating a control plane topology of a centralized and distributed structure of an intrusion prevention system according to an embodiment of the present disclosure.

FIGS. 8A and 8B are diagrams illustrating a topology of an intrusion detection system (IDS) applicable to an intrusion prevention system according to an embodiment of the present disclosure.

FIGS. 9A and 9B are flowcharts illustrating an event-driven intrusion detection and prevention method according to the present embodiment.

FIG. 10 is a diagram illustrating a use case scenario supporting usefulness of an intrusion prevention system according to the present disclosure.

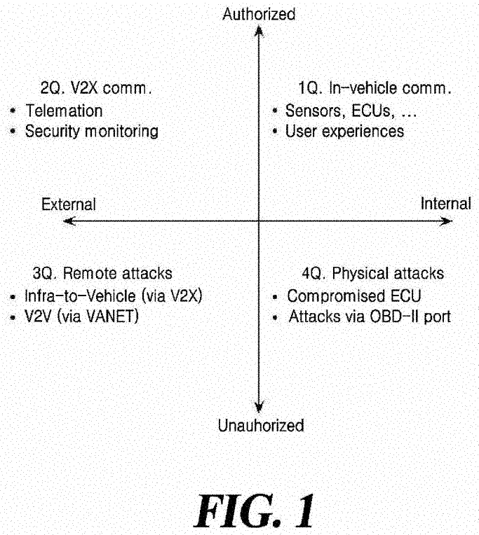

### DETAILED DESCRIPTION

Hereinafter, some embodiments of the present disclosure will be described in detail with reference to the accompanying drawings. It should be noted that, in adding reference numerals to the constituent elements in the respective drawings, like reference numerals designate like elements, although the elements are shown in different drawings. Further, in the following description of the present disclosure, a detailed description of known functions and configurations incorporated herein will be omitted to avoid obscuring the subject matter of the present disclosure.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The detailed description, which will be given below with reference to the accompanying drawings, is intended to explain exemplary embodiments of the present invention, rather than to show the only embodiments that can be implemented according to the present invention.

The present disclosure generally relates to an intrusion prevention method and an intrusion prevention system for detecting and preventing an attack on an Ethernet-based in-vehicle network (IVN) using a software-defined network (SDN) technology.

The SDN is a technology that separates a control part of network devices such as switches and routers from a data transmission part of the network devices and provides open interfaces for defining functions of the network devices enabling development of software that can set, control and manage various network paths and the flow of network traffic via the open interfaces.

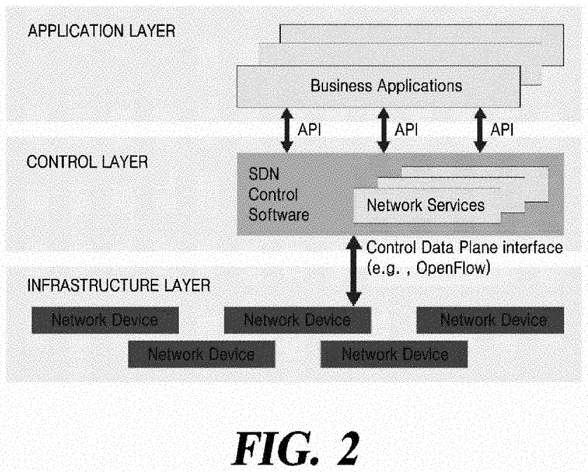

FIG. 2 is a conceptual diagram illustrating architecture of a typical SDN. The SDN architecture is defined as three layers including an application layer, a control layer, and an infrastructure layer. The application layer, control layer, and infrastructure layer are also called an application plane, a control plane, and an infrastructure plane (or a data plane), respectively. These layers communicate with each other through open interfaces. An open interface between the application layer and the control layer, which is referred to as a “northbound API”, is an API enabling the development of applications with various functions and communication with other operating tools, and Restful APIs are generally used in the northbound API. An open interface between the control layer and the infrastructure layer, which is referred to as “southbound API”, is an interface for forwarding control, information gathering, etc., and may include, for example, OpenFlow, OF-config, Netconf, etc.

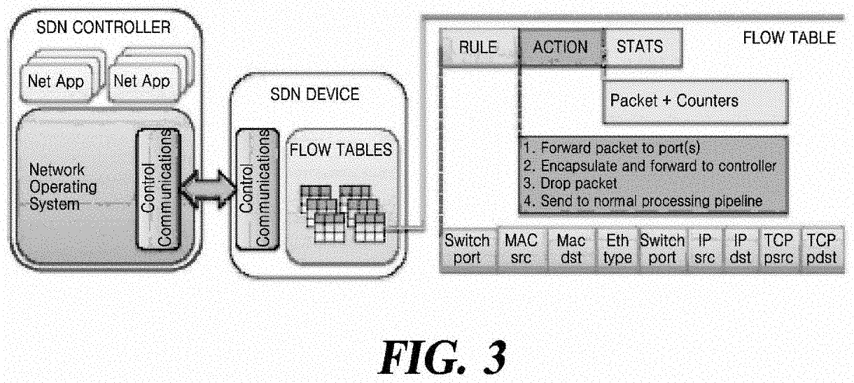

FIG. 3 illustrates an SDN system including an SDN controller and an SDN device, and fields of a set of flow entries contained in a flow table mounted in the SDN device. The SDN controller, which is a logical entity, is disposed in the control plane of the SDN system, and the SDN device, which is a hardware device, is disposed in the data plane. The flow table mounted in the SDN device includes the following three main fields to process a packet received by the SDN device. The main fields include packet header information (Rule field) defining a flow, an ACTION field indicating how to process a packet, and an STATS field representing statistics for each flow. A controller may create flow tables in a switch using the southbound API, which includes a function to register a new flow entry or delete a flow entry.

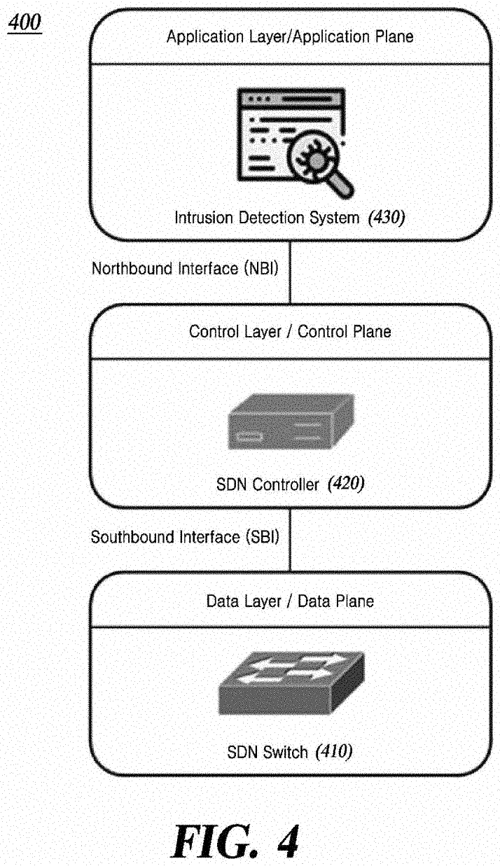

FIG. 4 is a conceptual diagram schematically illustrating a structure of an intrusion prevention system according to an embodiment of the present disclosure.

As described above, the intrusion prevention system 400 of the present disclosure utilizes the SDN technology. Since an SDN is a virtualized architecture, it is not necessary to physically co-locate components thereof. According to the intrusion prevention system 400 of the present disclosure, an in-vehicle network (IVN) having an SDN-enabled switch (shortly, SDN switch) 410 is disposed on the data plane of the SDN system, an SDN controller 420 is disposed on the control plane of the SDN system, and an intrusion detection system (IDS) 430 is disposed on the application plane of the SDN system.

The intrusion prevention system 400 separates, from the IVN, a logical or physical entity which determines whether there is an intrusion by analyzing a state of a vehicle in which traffic occurs and the traffic and determines a response according to a determination result from the IVN. An operating subject of the IDS 430 may be different from an operating subject of the SDN controller 420.

The SDN-enabled switch 410 provided in the IVN controls traffic occurring in the IVN or traffic flowing into the IVN based on the flow table. The SDN controller 420, which is located remotely from the vehicle and is connected to the vehicle through V2I communication, may receive suspicious traffic from the SDN-enabled switch 410 and determine an action of the SDN-enabled switch 410 regarding the suspicious traffic according to a determination result from the IDS 430 regarding whether the received traffic is traffic related to an attacker's intrusion.

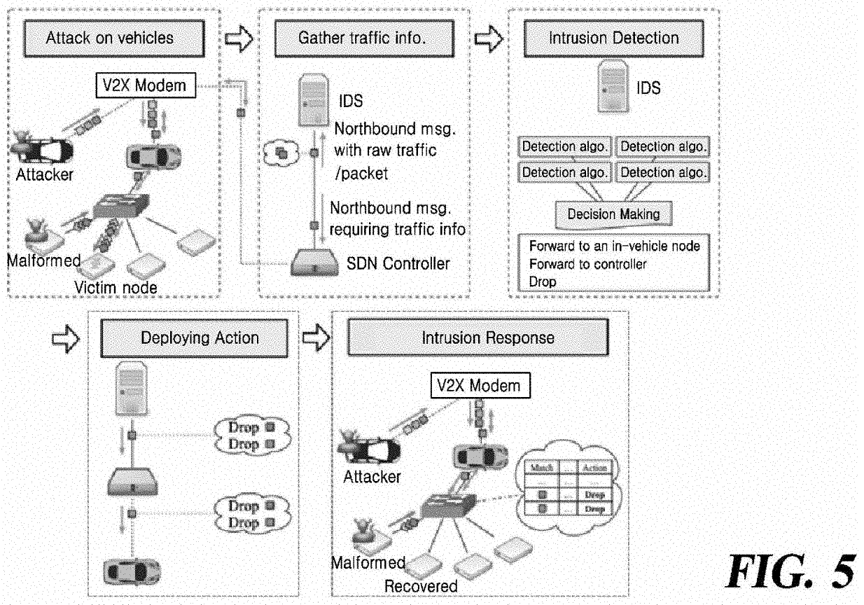

FIG. 5 is a conceptual diagram schematically illustrating an operation of an intrusion prevention system according to an embodiment of the present disclosure.

(STEP 1) Attack on vehicle: An attack on the vehicle occurs. The attack may be either an internal attack (e.g., malformed packets from a compromised ECU) or an external attack (e.g., attempting from the Internet or nearby vehicles via V2V communication).

(STEP 2) Gathering traffic information: The SDN-enabled switch 410 gathers packets coming from inside or outside the vehicle, and the gathered packets are transferred to an external IDS through the SDN controller 420.

(STEP 3) Intrusion detection: The IDS 430 analyzes an incoming packet using various detection methodologies. The IDS 430 may selectively transmit detected attack information to another IDS (not shown) or an analysis system to make a more accurate decision as needed. The other IDS (not shown) or analysis system may perform deep packet inspections, network forensics, identification of a root cause of an attack, establishment and distribution of some countermeasures in the IDS 430, and the like.

(STEP 4) Deploying action: The SDN controller 420 receives a determination of an intrusion or an action according to a determination result from the IDS 430.

(STEP 5) Intrusion response: The SDN-enabled switch 410 develops an operation of packet control (e.g., dropping a packet, forwarding to a destination node, temporarily blocking an input source, etc.).

Hereinafter, the functions and operations of the SDN-enabled switch 410, the SDN controller 420, and the IDS 430 in the proposed intrusion prevention system 400 are described in detail.

The SDN-enabled switch 410 is mounted in the vehicle and controls a flow of all traffic or packets (hereinafter, collectively referred to as “packets”) flowing in IVN or V2X communication of the vehicle. The SDN-enabled switch 410 may be an SDN switch or a common switch combined with an SDN device to operate in an SDN environment, but is not limited thereto. For example, the SDN-enabled switch 410 according to the present embodiment may be any switch as long as the switch is able to control a flow of packets generated in an IVN of a vehicle or in V2X environment and communicate with the SDN controller 420 of the control plane.

The SDN-enabled switch 410 controls the packets flowing into the SDN-enabled switch 410 using the flow table. According to one aspect of this embodiment, the SDN-enabled switch 410 compares packet-related data such as port information with a rule field of each flow entry in the flow table, and then extracts or refers to a flow entry matched to a given packet. Such matching varies depending on a specification of the southbound API corresponding to a communication protocol between the SDN-enabled switch 410 and the SDN controller 420. For example, as shown in FIG. 4, the rule field of the flow entry may include a switch port, a MAC source (Mac src), an Ethernet type (Eth type), a VLAN ID, an IP source (IP src), etc. In this case, matching between packet data and a flow entry may be established when (1) all match, (2) match within a preset range, or (3) match more than a preset number with respect to the specification of the rule field. In this case, there may be a plurality of flow entries matched to the given packet.

When there is a flow entry matched to the incoming packet, the SDN-enabled switch 410 extracts the flow entry and executes a command of an action field of the flow entry. According to an aspect of the present embodiment, when there are a plurality of flow entries matched to the incoming packet, the SDN-enabled switch 410 may refer to a priority field included in each flow entry and may extract a flow entry having the highest priority among the plurality of flow entries.

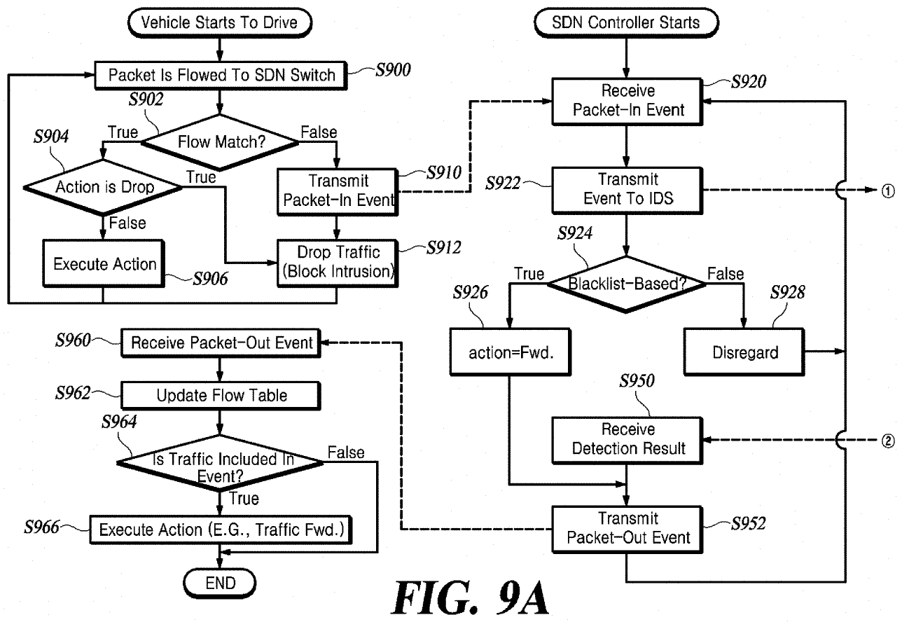

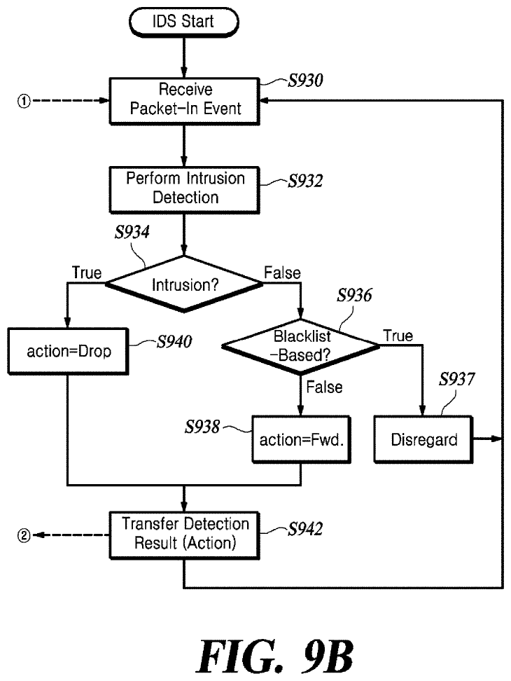

Transmission of all packets flowing into the SDN-enabled switch 410 to the SDN controller 420 may cause privacy infringement and waste of resources. Thus, according to an aspect of the present embodiment, the SDN-enabled switch 410 may employ an event-driven detection method in which a packet is transmitted only when a specific event occurs. The “event” refers to a case in which packet control cannot be performed using only the flow table, such as a case in which there is no flow entry matched to the incoming packet and a case in which a validity period of the matched flow entry has already expired. When such an event occurs, the SDN-enabled switch 410 assumes that the incoming packet is a new intrusion packet that has not been determined or inspected by the intrusion prevention system 40, and drops the incoming packet or transmits the incoming packet to the SDN controller for the purpose of intrusion detection 420. When the event occurs, the packet transmission may be achieved by extracting a table-miss entry having the lowest priority in the flow table and performing a forward-to-the controller command contained in an action field of the table-miss entry. The packet transmission may be achieved by sending the SDN-enabled switch 410 to the SDN-enabled switch 410 a packet-in message which includes all or part of the incoming packet and data associated with the incoming packet and is generated in compliance with an interface adopted by the SDN-enabled switch 410 and the SDN controller 420. The event-driven intrusion detection method is described in detail later with reference to FIGS. 9A and 9B.

According to another aspect of the present embodiment, by configuring the action field of the flow entry matched to the specific packet to contain the forward-to-controller command, the corresponding packet may be transmitted to the SDN controller 420 for monitoring.

The flow entry may further include a statistics field (STATS field of FIG. 4) as well as the rule field and action field described above. The statistics field is a field for storing statistical data collected or calculated for packets, and may include a counter field. The counter field records the number of times the rule field of the flow entry is matched to incoming packets, and the number of times may be cumulatively increased or be initialized with a preset period in some cases. The counter field may contain a match counter which is set to count the number of matches with the incoming packets within a predetermined reference value or may further contain a byte counter which is set to count the number of bytes per second of the matched packet.

The SDN-enabled switch 410 may update the flow table only when receiving a message from the SDN controller 420. The SDN-enabled switch 410 operates in a fail-safe mode when communication with the SDN controller 420 (e.g., communication based on the southbound API) is cut or until the connection to the SDN controller 420 resumes during cold boot (e.g., engine start). In the fail-safe mode, the SDN-enabled switch 410 may control the packet flow based on a flow table set as a default by a vehicle manufacturer. In this case, the SDN-enabled switch 410 operates as a common switch.

The SDN controller 420 receives a packet from the SDN-enabled switch 410 and transmits the received packet to the IDS 430, and receives an intrusion packet determination result and a corresponding action from the IDS 430 and transmits the received results and action to the SDN-enabled switch 410. Specifically, according to an aspect of the present embodiment, the SDN controller 420 receives a packet-in message which is generated in compliance with an interface (e.g., the southbound API) used in communication with the SDN-enabled switch 410 and includes all or part of the packet. The SDN controller 420 transforms the received packet-in message to conform to a specification of the interface (e.g., northbound API) used for communication with the IDS 430 and transmits the transformed message to the IDS 430. The SDN controller 420 receives an action related to a packet flow from the IDS 430 and generates a packet-out message. The SDN controller 420 transmits the packet-out message to the SDN-enabled switch 410 so that the SDN-enabled switch 410 may update the flow table or control a flow of an incoming packet corresponding to the packet-out message.

The SDN controller 420 may be a dedicated controller for SDN, or a general controller combined with an SDN device to operate in an SDN environment, but is not limited thereto. For example, the SDN controller 42 according to the present embodiment may include any controller as long as the controller is able to manage packets generated in the IVN or V2X environment and communicate with the SDN-enabled switch 410 or a vehicle equipped the SDN-enabled switch 410.

The SDN controller 420 may generate a new rule capable of filtering out a corresponding packet according to the determination result of whether the packet is an intrusion packet or an action received from the IDS 430, and may further include the generated new rule in the packet-out message. Such a new rule may be generated by receiving it from the IDS 430 or an external device.

According to another aspect of the present embodiment, the SDN controller 420 may perform management of a southbound API-based connection such as OpenFlow, flow table management, or packet statistics gathering with one or more SDN-enabled switches 410 mounted in one or more vehicles. The SDN controller 420 may also perform management of a northbound API-based connection, such as an ad-hoc API, RESTful API, or other programming interface, with one or more IDSs (such as 430 in FIG. 4).

The operation of the SDN controller 420 is described using OpenFlow as an example.

When initially connected with the SDN-enabled switch 410, the SDN controller 420 establishes a session upon receiving the OFPT_HELLO message with an identifier and a data path ID (DPID) in the OpenFlow specification.

When a table miss occurs, such as when there is no flow entry matched to an incoming packet in the flow table, the SDN-enabled switch 410 transmits an OFPT_PACKET_IN message to the SDN controller 420. The OFPT_PACKET_IN message contains the incoming packet that caused the table miss. Upon receiving the OFPT_PACKET_IN message, the SDN controller sends an OFPT_PACKET_OUT message containing the OFPT_PACKET_IN message and a response (e.g., an action) to the OFPT_PACKET_IN message to the SDN-enabled switch 410. Until sending of the OFPT_PACKET_OUT message, the SDN controller 420 may request the IDS 430 to determine whether the incoming packet contained in the OFPT_PACKET_IN message is an intrusion packet.

The SDN controller 420 may request flow statistics from the IDS 430 or the SDN-enabled switch 410. For example, the SDN controller 420 may periodically monitor the IVN of each vehicle to determine whether there is a network abnormality, and request statistics of an individual flow entry, multiple flow entries, or the flow table from the SDN-enabled switch 410 or the vehicle equipped with the SDN-enabled switch 410 through messages such as OFPMP_FLOW, OFPMP_AGGREGATE or OFPMP_TABLE. As a result, the SDN controller 420 may receive a timestamp recording the number of packets on the IVN, the number of bytes, and a matching time with incoming packets for each flow entry.

The IDS 430 communicates with the SDN controller 420, receives a packet or a packet-in message containing the packet from the SDN controller 420, determines whether the packet is an intrusion packet, determines an action for the packet depending on whether the packet is an intrusion packet, and transmits the action to the SDN controller 420. For example, according to an aspect of the present embodiment, when the target packet is determined to be an intrusion packet, the IDS 430 may determine a drop command to drop the target packet as an action. According to another aspect of this embodiment, in the same case, the IDS 430 may determine a drop and forward-to-controller command for the type of packet as an action. This action causes the SDN-enabled switch 410 to drop the type of packet in the IVN and forward the type of packet to the SDN controller 420 so that the SDN controller 420 can monitor the type of packet.

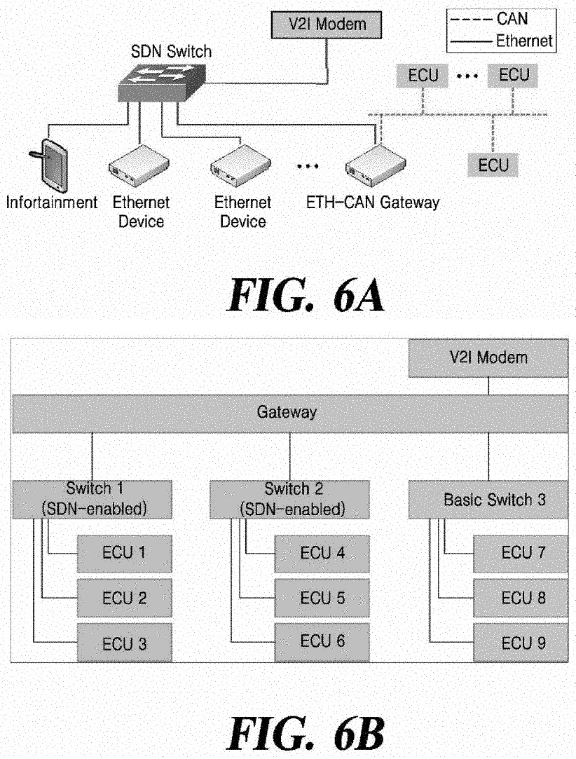

Hereinafter, exemplary topologies of a data plane, a control plane, and an application plane of the proposed intrusion prevention system are described with reference to FIGS. 6A, 6B, 7A, 7B, 8A, and 8B, respectively.

FIGS. 6A and 6B are diagrams illustrating an exemplary topology of an IVN according to an embodiment of the present disclosure.

FIG. 6A illustrates an exemplary topology of an IVN with a hybrid structure. The illustrated IVN includes various Ethernet devices, infotainment devices, one or more electronic control units (ECUs), and an Ethernet-based LAN including an SDN switch connected to these devices. Typically, high-speed data applications such as advanced driver-assistance system (ADAS) and multimedia may be connected to the SDN switch via an Ethernet-based LAN. The illustrated IVN includes a legacy CAN bus for some applications for which Ethernet is not suitable, such as power train systems that require message prioritization. The legacy CAN bus may be connected to the SDN-enabled switch via an ETH-CAN gateway supporting communication between Ethernet and the CAN bus. The SDN switch may communicate with other devices including the SDN controller 420 located remotely, servers, systems, etc. through a V2I communication modem.

FIG. 6B illustrates an exemplary topology of an Ethernet-based IVN. The illustrated IVN includes 3 switches (i.e., switch 1, switch 2, and basic switch 3) and nine ECUs. It should be noted that the number of switches or the number of ECU devices may vary depending on the method of configuring the topology. To ensure that all packets generated by the ECUs are passed through a switch to respective destination nodes, each ECU must be connected to the switch alone, and multiple ECUs do not occupy a single bus-line.

Switch 1 and switch 2 are SDN-enabled switches with an activated SDN function. The two switches are connected to the SDN controller through a wireless modem responsible for communication between the vehicle and an external infrastructure (i.e., V2I communication). When a connection with the SDN controller is established, switch 1 and switch 2 process packets of ECU 1 to ECU 6 based on actions received from the SDN controller, and cannot determine the action of each packet by themselves. However, when the connection with the SDN controller is cut off due to a failure of the wireless modem, switch 1 and switch 2 operate like basic switch 3, which will be described below. Accordingly, the vehicle based on the intrusion prevention system 400 according to the present embodiment may maintain a normal operation even in an emergency (e.g., fail-safe operation) and allow each function of the intrusion prevention system 400 to be selectively applied.

According to a command or action received from the SDN controller, switch 1 and switch 2 may block packets considered to be an attack, without forwarding the packets to other ECUs, and in addition, switch 1 or switch 2 may transmit it to the SDN controller for post-analysis. Determination of whether the packet corresponds to an intrusion by an attacker is performed by an external intrusion detection system.

Basic switch 3 is not an SDN-enabled switch according to the present embodiment, but a conventional switch that performs MAC address learning and that has been adopted to an existing vehicle. When basic switch 3 knows a destination of a packet sent by ECU 7 to ECU 9, basic switch 3 forwards the packet to a specific port, and when basic switch 3 does not know the destination, basic switch 3 broadcasts the packet to all ports. Basic switch 3 does not support packet information gathering function for intrusion detection/prevention and does not receive an action designated to control a packet flow from an external device such as the SDN controller.

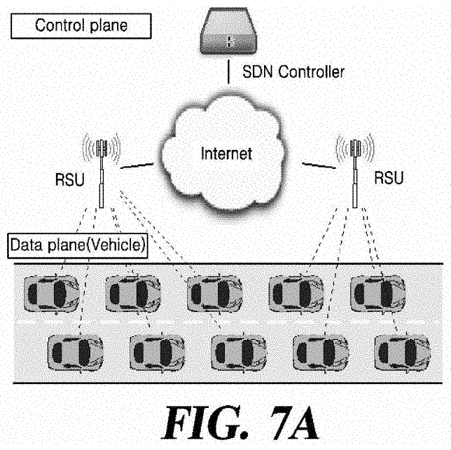

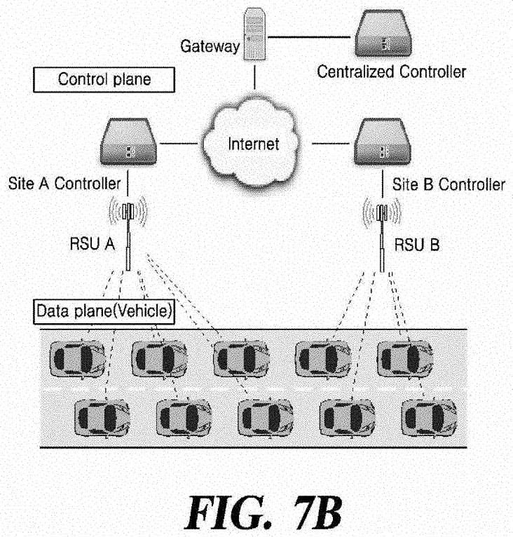

FIGS. 7A and 7B are diagrams illustrating a control plane topology of a centralized structure and a distributed structure of an intrusion prevention system according to an embodiment of the present disclosure.

Typically, the SDN controller disposed in the control plane may transmit and receive data to and from SDN switches within a plurality of vehicles. FIG. 7A illustrates a centralized structure in which a single SDN controller manages all packets of vehicles. The IDS of the present disclosure may achieve the intended purpose may with only one SDN controller, but multiple SDN controllers may also be introduced and operated in consideration of latency and load balancing. FIG. 7B illustrates a distributed structure in which each of several base SDN controllers manage one or more vehicles that are physically or logically close thereto. For example, the SDN controllers may be implemented in an edge cloud server or a fog server for each base. The SDN controllers for each base may perform primary communication with a vehicle that is physically or logically close thereto and deliver a corresponding result to a centralized SDN controller. In the centralized architecture, the single SDN controller performs communication with the IDS 430 using the northbound API, and in the distributed architecture, the central SDN controller performs communication with the IDS 430 using the northbound API.

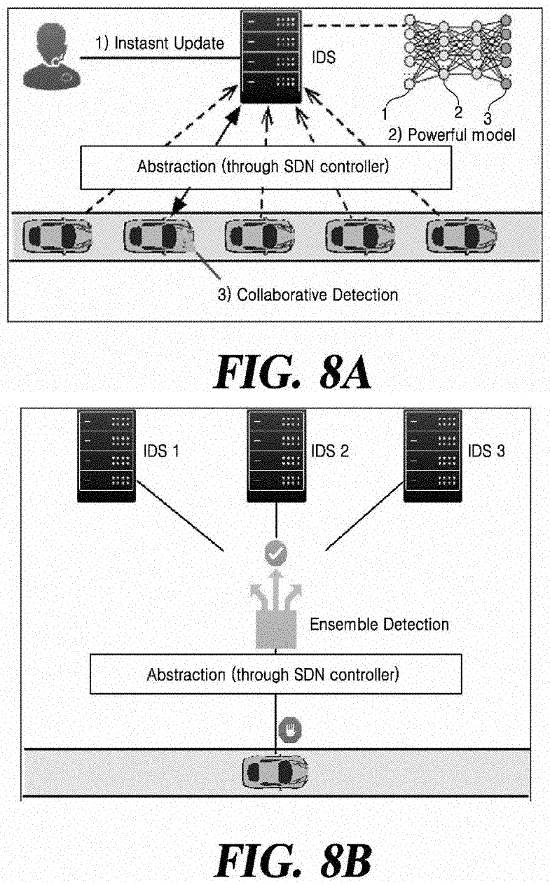

FIGS. 8A and 8B are diagrams illustrating topology of an IDS applicable to an intrusion prevention system according to an embodiment of the present disclosure.

Recently proposed Deep Learning-based IDSs requires more resources such as GPU to obtain precise detection results. A computing system mounted in a vehicle has minimum performance required for driving, and thus, the computing system is inappropriate for operating the Deep Learning-based IDS. An IDS located remotely from the vehicle no longer have to consider in-vehicle performance issues for computing intrusion detection algorithms. Therefore, the proposed intrusion prevention system may employ an IDS that operates a precise intrusion detection algorithm requiring high computing power, such as a deep learning algorithm illustrated in FIG. 8A.

In the proposed intrusion prevention system, several IDSs may be operated concurrently. Each IDS is responsible for intrusion detection for a specific protocol (e.g., IDS 1 for SSH, IDS 2 for AVTP, IDS 3 for UDP), alternatively, as illustrated in FIG. 8B, an ensemble technique using detection results of several IDSs operating different detection algorithms may be used.

Disposing the IDS remotely from the vehicle rather than within the IVN provides a lot of flexibility in the operation of the intrusion prevention system. The IDS may be updated in real time regardless of a location or status of the vehicle being analyzed. For example, the IDS may dynamically add, reconfigure, or remove an intrusion detection model or algorithm even when the vehicle to be analyzed is driving. In addition, if a new function is introduced in an individual vehicle or a new attack pattern against an individual vehicle is discovered, an operator (or a service provider) can update the detection model using related data.

FIGS. 9A and 9B are flowcharts illustrating an event-driven intrusion detection and prevention method according to the present embodiment.

When a triggered event (e.g. table miss of an incoming packet or expiration of a flow entry matched to an incoming packet) occurs, the event-driven algorithm drops the packet, blocks traffic from a corresponding source, and then post-analyzes a packet flow, thereby enabling properly preventing an attack.

FIG. 9A illustrates a process in which the SDN-enabled switch 410 and the SDN controller 420 perform event-driven intrusion detection.

As can be seen from FIG. 9A, when a vehicle (e.g., CAV) to which the intrusion prevention system 400 according to the present embodiment is applied starts driving, a packet is flowed from the IVN or V2X environment to the SDN-enabled switch 410 (S900).

The SDN-enabled switch 410 determines whether there is a flow entry having a rule field matched to the packet in a flow table (S902).

If there is a matched flow entry, the SDN-enabled switch 410 determines whether a packet drop command is included in an action field of the matched flow entry (S904), and if there is no packet drop command, the SDN-enabled switch 410 performs a command of the action field without the packet drop (S906).

If there is a packet drop command, the SDN-enabled switch 410 drops the packet and blocks the corresponding traffic (S912).

When there is no flow entry matched to the incoming packet or when the matched flow entry expires so there is no matched flow entry resultantly, the SDN-enabled switch 410 transmits a packet-in message, which contains the incoming packet and event information such as a port number, to the SDN controller 420 located remotely from the vehicle (S910), drops the incoming packet, and blocks the corresponding traffic from the corresponding source (S912).

The SDN controller 420 receives the packet-in message from the SDN-enabled switch 410 (S920), and transmits the received packet-in message to the IDS 430 (S922).

The SDN controller 420 determines whether the event-driven intrusion detection is performed based on a blacklist (S924), and when the event-driven intrusion detection is performed based on a blacklist, the SDN controller 420 transmits a packet-out message which contains the incoming packet, having been contained in the packet-in message, and the forwarding action to the SDN-enabled switch 410 (S926, S952). In the blacklist-based intrusion detection, if a table miss occurs for a certain packet, the certain packet is regarded as not being included in the blacklist and is forwarded first. In this case, the attack is not identified and the certain packet is not dropped until the certain packet is determined as an intrusion packet later.

When the event-driven intrusion detection is not based on a blacklist, that is, when the even-driven intrusion detection is performed based on a whitelist, the SDN controller 420 does not immediately send a packet-out message to the SDN-enabled switch 410 (S928), but rather waits for a determination result from the IDS 430 and then send the packet-out message including an action determined according to the determination result (S952) to the SDN-enabled switch 410. The packet-out message may further include the packet which has been contained in the packet-in message, if necessary. In the whitelist-based intrusion detection, when a table miss occurs for a certain packet, the certain packet is regarded as not being included in a whitelist, and a packet flow is controlled according to a determination result later.

The SDN-enabled switch S400 receives the packet-out message (S960) and updates the flow table (S962). Such updating may include adding a new flow entry, updating expiration information of an expired flow entry or each field of a flow entry, or leaving the flow table as it is if there are no new contents to be updated.

When the received packet-out message includes a packet (S964), the SDN-enabled switch S400 controls a packet flow according to an action included in the packet-out message (S966).

FIG. 9B illustrates a process in which the IDS 430 performs event-driven intrusion detection.

The IDS 430 receives the packet-in message from the SDN controller 420 (S930) and performs intrusion detection (S932).

When it is determined that the packet contained in the packet-in message is not an intrusion packet (S934), if the intrusion detection is based on a blacklist (S936), the IDS 430 does not specify an action for the packet (S937). This is because the SDN controller 420 has already transmitted the packet-out message containing the forwarding action in steps S926 and S952. In this case, the IDS 430 does not transmit a determination result to the SDN controller 420.

If the intrusion detection is not based on a blacklist (S936), that is, if the intrusion detection is based on a whitelist, the IDS 430 includes a forwarding command in the action (S938).

When it is determined that the packet contained in the packet-in message is an intrusion packet (S934), the IDS 430 includes a drop command in the action for the packet (S940).

The IDS 430 transmits an action for the packet to the SDN controller S420 as a determination result (S942). Here, transmission data may include the packet itself, data associated with the packet, the determination result, etc.

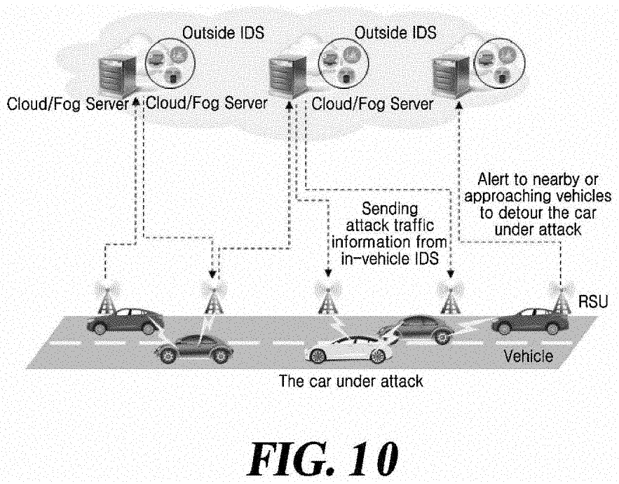

FIG. 10 is a diagram illustrating a use case scenario supporting usefulness of an intrusion prevention system according to the present disclosure.

(1) Whenever an attack is detected, all vehicles transmit the detected attack information to the IDS through the SDN controller on a cloud server or fog server. In this case, a road-side unit (RSU) may relay communication between an adjacent vehicle and each server. A communication method of the RSU may be based on a near field communication (NFC), Bluetooth low energy (BLE), wireless LAN (WIFI), ultra wideband (UWB), radio frequency, infrared data association (IrDA), Zigbee, LTE, or 5G.

(2) When a certain vehicle, which is one of vehicles to which the intrusion prevention system or method of the present disclosure is applied, is being attacked, the IDS mounted in the certain vehicle transmits attack traffic information or packets suspected of being an attack to the cloud server or fog server.

(3) The SDN controller on the cloud server or fog server sends the attack traffic information or the packets to the IDS, and the IDS analyzes the data. If it is determined that there is an attack, the IDS transmits a warning command to the certain vehicle to take a detour, to each nearby vehicle through the SDN controller.

(4) When vehicle-to-vehicle (V2V) communication is activated, the certain vehicle may share its state with adjacent vehicles.

(5) When remote control by an external device is permitted, the external device may control the certain vehicle to decelerate and pull-drive at the request of the cloud server or the fog server.

Although it is described that each process is sequentially executed in FIGS. 5, 9A and 9B, this is merely illustrative of the technical idea of an embodiment of the present disclosure. In other words, those skilled in the art to which an embodiment of the present disclosure pertains may make various modifications and variations to be applied such as executing the process by changing the order described in FIGS. 5, 9A, and 9B or executing one or more processes of each process in parallel, without departing from the essential characteristics of an embodiment of the present disclosure, and thus, the present disclosure is not limited to the time-series sequence of FIGS. 5, 9A, and 9B.

Various implementations of the systems and techniques described herein may be realized by digital electronic circuitry, integrated circuits, field programmable gate arrays (FPGAs), application specific integrated circuits (ASICs), computer hardware, firmware, software, and/or combinations thereof. These various implementations may include implementation as one or more computer programs executable on a programmable system. The programmable system includes at least one programmable processor (which may be a special-purpose processor or a general-purpose processor) coupled to receive data and instructions from a storage system, at least one input device, and at least one output device and transmit data and instructions thereto. Computer programs (also known as programs, software, software applications, or code) include instructions for a programmable processor and are stored in a “computer-readable medium”.

The computer-readable recording medium includes all types of recording devices in which data readable by a computer system is stored. The computer-readable recording medium may be non-volatile or non-transitory mediums, such as ROM, CD-ROM, magnetic tape, floppy disk, memory card, hard disk, magneto-optical disk, and storage device and may further include a transitory medium such as a data transmission medium. In addition, the computer-readable recording medium may be distributed in a network-connected computer system, and a computer-readable code may be stored and executed in a distributed manner.

Various implementations of the systems and techniques described herein may be implemented by a programmable computer. Here, the computer includes a programmable processor, a data storage system (including volatile memory, non-volatile memory, or other types of storage systems, or combinations thereof), and at least one communication interface. For example, the programmable computer may be one of a server, a network appliance, a set-top box, an embedded device, a computer expansion module, a personal computer, a laptop, a personal data assistant (PDA), a cloud computing system, or a mobile device.

### DESCRIPTION OF REFERENCE NUMERALS

400: Intrusion Prevention System

410: SDN-enabled switch

420: SDN controller

430: Intrusion Detection System (IDS)

### CROSS-REFERENCE TO RELATED APPLICATION

This application claims priority to Korean Patent Application No. 10-2019-0093503, filed on Jul. 31, 2019, and Korean Patent Application No. 10-2020-0095518, filed on Jul. 30, 2020, the entire contents of which are incorporated herein by reference.

What is claimed is:

1. An intrusion prevention system for an in-vehicle network (IVN), the intrusion prevention system comprising:
a software-defined networking (SDN)-enabled switch installed in the IVN of a vehicle and configured to control a packet flow of an incoming packet by referring to a flow entry, in a flow table, corresponding to the incoming packet; and
an SDN controller configured to communicate with the SDN-enabled switch, receive the incoming packet from the SDN-enabled switch, and transmit an action corresponding to the incoming packet to the SDN-enabled switch,
wherein the SDN controller is further configured to transmit the incoming packet to an intrusion detection system (IDS) so that the IDS determines whether the incoming packet is an intrusion packet, receive an action based on a determination result from the IDS, and transmit the received action to the SDN-enabled switch, as the action corresponding to the incoming packet.

2. The intrusion prevention system of claim 1, wherein the flow entry includes a rule field, an action field, and a counter field, and
wherein the SDN-enabled switch is further configured to compare data of the incoming packet with the rule field of each flow entry of the flow table, extract a flow entry in which the number of matches or a matching range is equal to or greater than a certain reference value, update the counter field of the extracted flow entry and control a flow of the incoming packet according to the action field of the extracted flow entry.

3. The intrusion prevention system of claim 1, wherein,
when communication between the SDN-enabled switch and the SDN controller is connected, the SDN switch is further configured to receive the action from the SDN controller and update the flow table, and
when the communication between the SDN-enabled switch and the SDN controller is disconnected or when the vehicle is cold-booted, the SDN-enabled switch is further configured to control the incoming packet based on a preset flow table, as a common switch.

4. A method for detecting and preventing a vehicle intrusion using a software-defined networking (SDN)-enabled switch installed in an in-vehicle network (IVN) of a vehicle and an SDN controller located remotely from the vehicle, the method comprising:
transmitting, by the SDN-enable switch, to the SDN controller a packet-in message containing an incoming packet flowed from the IVN;
receiving, by the SDN controller, the packet-in message and transmitting the received packet-in message to an intrusion detection system (IDS);
enabling, by the SDN controller, the IDS to determine whether the incoming packet is an intrusion packet, and receiving, by the SDN controller, an action based on a determination result from the IDS;
transmitting, by the SDN controller, a packet-out message including the action based on the determination result to the SDN-enabled switch; and
controlling, by the SDN-enabled switch, a packet flow of the incoming packet according to the action based on the determination result.

5. The method of claim 4, further comprising:
extracting, by the SDN-enabled switch, a flow entry matched to the incoming packet from a flow table.

6. The method of claim 5, wherein the flow entry includes a rule field, and
wherein, the extracting of a flow entry matched to the incoming packet includes:
comparing data of the incoming packet to the rule field of each flow entry; and
extracting a flow entry in which the number of matches or a matching range is equal to or greater than a certain reference value.

7. The method of claim 6, wherein the flow entry further includes a priority field, and
wherein the extracting of a flow entry matched to the incoming packet includes:
when a plurality of flow entries is extracted from the flow table, extracting one flow entry matched to the incoming packet based on the priority field of each flow entry is extracted.

8. The method of claim 6, wherein the transmitting of the packet-in message to the SDN controller is performed when an event occurs that there is no extracted flow entry or that the extracted flow entry has expired, or when a forward-to-controller command is included in an action field of the extracted flow entry.

9. The method of claim 8, wherein the transmitting of the packet-in message to the SDN controller includes dropping the incoming packet when the event occurs; and
wherein, when it is determined that the incoming packet is not an intrusion packet, the packet-out message further includes the incoming packet.

10. The method of claim 9, wherein, when the incoming packet is an intrusion packet, the packet-out message further includes a new rule for extracting the incoming packet.

11. The method of claim 4, further comprising:
transmitting, by the SDN controller, a packet-out message to the SDN-enabled switch, before the SDN controller receives the action based on the determination result from the IDS, wherein the packet-out message includes the incoming packet and an action for commanding forwarding of the incoming packet.

12. The method of claim 4, further comprising:
updating, by the SDN-enabled switch, the flow table based on the packet-out message.
